(19) United States
(12) Patent Application Publication
(10) Pub. No.: US 2008/0306633 A1
(43) Pub. Date: Dec. 11, 2008

(54) OPTIMIZED POWER AND AIRFLOW MULTISTAGE COOLING SYSTEM

(75) Inventors: Eric Tunks, Austin, TX (US); Paul T. Artman, Austin, TX (US); Phil Baurer, Tremont, IL (US); Robert L. Riegler, Austin, TX (US)

Correspondence Address: HAYNES AND BOONE, LLP, 901 Main Street, Suite 3100, Dallas, TX, 75202, US

(73) Assignee: DELL PRODUCTS L.P., Round Rock, TX (US)

(21) Appl. No.: 11/759,749

(22) Filed: Jun. 7, 2007

(51) Int. Cl. G05D 23/00

(52) U.S. Cl. 700/300

(57) ABSTRACT

A system for adjusting the operation of a cooling device includes a cooling device, an input sensory device, a control algorithm, and a controller that adjusts operation of the cooling device based on the control algorithm. An embodiment of the control algorithm approximates a plurality of substantially linear cooling curves to relate to portions of a non-linear cooling curve for the cooling device, the algorithm selects a selected cooling curve from the plurality of substantially linear cooling curves based on an input from the sensory device. The system and an associated method may be implemented to cool an information handling system.

### BACKGROUND

The present application relates to cooling systems. Specifically, the present application relates to an optimized power and airflow multistage fan system.

Cooling systems are used in many areas of everyday life, from cooling our automobiles and homes to cooling the electronic devices in our automobiles and homes. Many cooling systems operate in two modes, on and off. When cooling is needed, the system turns on. When cooling is no longer needed, the system turns off. These systems can be inefficient because they oftentimes over cool thereby using too much power to perform the needed cooling. In addition, these systems are noticeably loud when on and get louder with increased power. Other cooling systems operate with respect to the temperature of the object to be cooled. In other words, when object of the cooling cools down, the cooling system slows down or stops. Then, when the object of the cooling heats up, the cooling system speeds up. This type of cooling system may be more efficient than an on/off cooling system that operates in two modes, but, sometimes these systems overcool the object of the cooling and therefore, there is room for improvement in the art. Thus, it is desirable to improve efficiency and reduce unnecessary noise of cooling systems.

### SUMMARY

A system and method of adjusting the operation of a cooling device is provided. An embodiment of the system includes a cooling device, an input sensory device, a control algorithm, and a controller that adjusts operation of the cooling device based on the control algorithm. An embodiment of the control algorithm approximates a plurality of substantially linear cooling curves to relate to portions of a non-linear cooling curve for the cooling device, the algorithm selects a selected cooling curve from the plurality of substantially linear cooling curves based on an input from the sensory device.

### BRIEF DESCRIPTION OF THE DRAWINGS

FIG. 1 shows a block diagram of an embodiment of an information handling system (IHS).

FIG. 2 shows a block diagram of an embodiment of a motherboard of the IHS of FIG. 1.

FIG. 3 shows a flow chart of a prior art cooling system method.

FIG. 4 shows a prior art linear cooling curve.

FIG. 5 shows an embodiment of a method of using a plurality of linear cooling curves to result in a non-linear cooling curve.

FIG. 6 shows a chart showing a benefit of an optimized cooling system.

FIG. 7 shows a flow chart of an embodiment of a method for an optimized power and airflow multistage fan system.

### DETAILED DESCRIPTION

For purposes of this disclosure, an IHS includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, read only memory (ROM), and/or other types of nonvolatile memory. Additional components of the IHS may include one or more disk drives, one or more network ports for communicating with external devices as well as various input and output (I/C) devices, such as a keyboard, a mouse, and a video display. The IHS may also include one or more buses operable to transmit communications between the various hardware components.

FIG. 1 is a block diagram of one IHS 100. The IHS 100 may have a motherboard 101. The motherboard 101 may be a “central nervous system” for the IHS 100 as is commonly understood in the art. The IHS 100 includes a processor 102 such as an Intel Pentium series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. It is also becoming feasible to use solid state drives (SSDs) 126 in place of, or in addition to main memory 108 and/or a hard disk drive 116.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

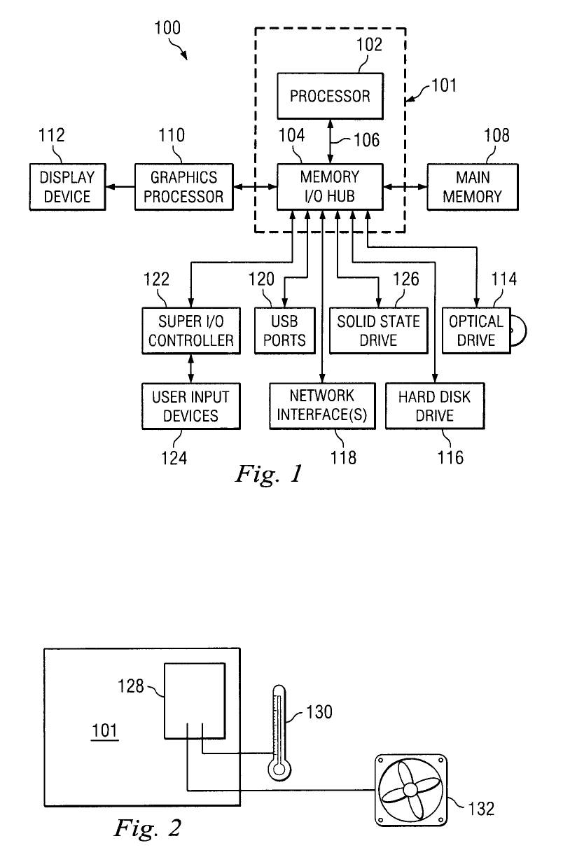

FIG. 2 shows an embodiment of a motherboard 101 for an information handling system 100. The motherboard 101 has a baseboard management controller (BMC) 128. BMCs 128 are common in the industry and are readily understood by those of ordinary skill in the art. A BMC 128 generally is a specialized controller device that may be embedded with the motherboard 101 of IHSs 100. BMCs 128 are commonly used on server-type IHSs 100, but may be used for any type of use. The BMC 128 may be a stand alone device. A function of the BMC 128 is to control an interface between the IHS 100 platform hardware and a system management software. Sensor devices, such as an ambient temperature sensor 130, cooling fan speed sensor (not shown), power sensor (not shown), and others (not shown) may be coupled with the BMC 128. The BMC 128 monitors inputs from the sensor 130 and can control the operation of devices, such as a cooling fan 132, to keep components of the IHS 100 from overheating. The function of the BMC 128 may be performed by any type of controller device and to control any type of function.

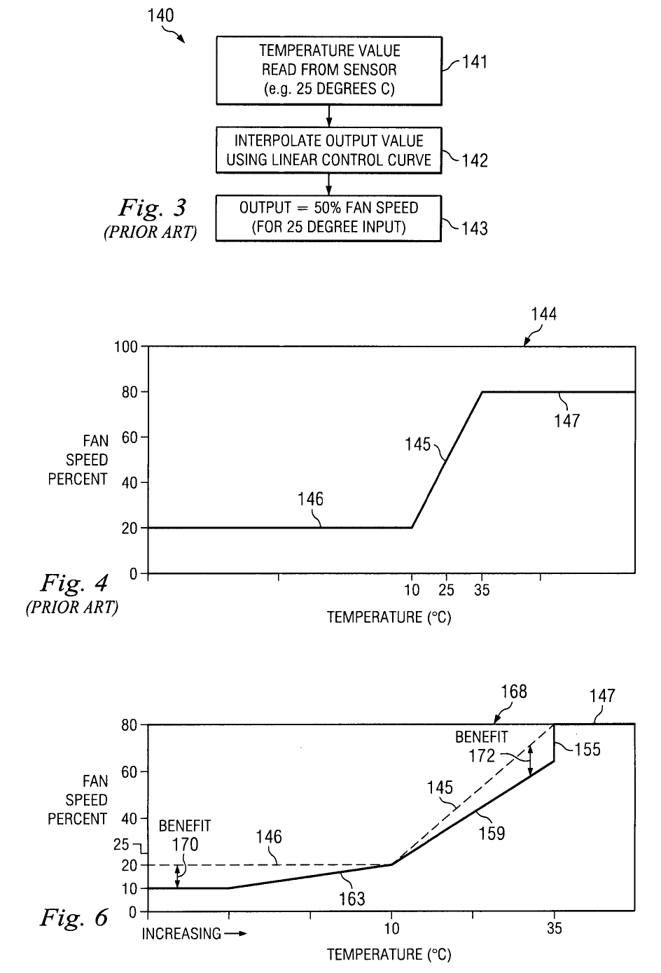

Generally, when the ambient temperature increases or decreases, as sensed by the ambient temperature sensor 130, the BMC 128 linearly adjusts power to the cooling fan 132 at a pre-determined rate up to and down to pre-set cutoff levels. FIG. 3 shows a prior art cooling system method 140. In step 141, this method reads a value from a sensor, such as, a temperature sensor 130. Next, in step 142, the control system, such as, a BMC 128 interpolates an output value for operating a device, such as the fan 132, using a pre-determined linear control curve, such as the fan control implementation graph or cooling curve 144 shown in FIG. 4. Finally, in step 143, the output, here a fan speed output, is sent to the fan 132 to operate the fan 132 at the speed interpolated from the cooling curve 144 using the value from the input sensor, here the temperature sensor 130.

In other words, using the cooling curve 144, the fan 132 will operate at a variable power/output level along a ramped portion 145 of the cooling curve. As an example, an ambient temperature of 25 C corresponds to a fan speed of 50% of full speed to obtain the desired cooling at that temperature. When the temperature increases, as shown along a bottom axis of FIG. 4, the fan speed is ramped accordingly, as shown along a left vertical axis of FIG. 4. Once the sensed temperature reaches a pre-determined low threshold, in this example 10 C, the fan speed will be set at 20% full speed, as shown at the fan constant low portion 146 of the cooling curve 144. Likewise, once the sensed temperature reaches a pre-determined high threshold, in this example 35 C, the fan speed will be set at 80% full speed, as shown at the fan constant high portion 147 of the cooling curve 144. As can be seen, the ramping portion 145 only allows for a single slope of cooling curve to be used. Therefore, if the system has an optimal cooling curve that varies in slope at different input temperatures, inefficiencies result in too much or too little power going to the fan 132 and possibly, too much noise is being produced by the fan 132.

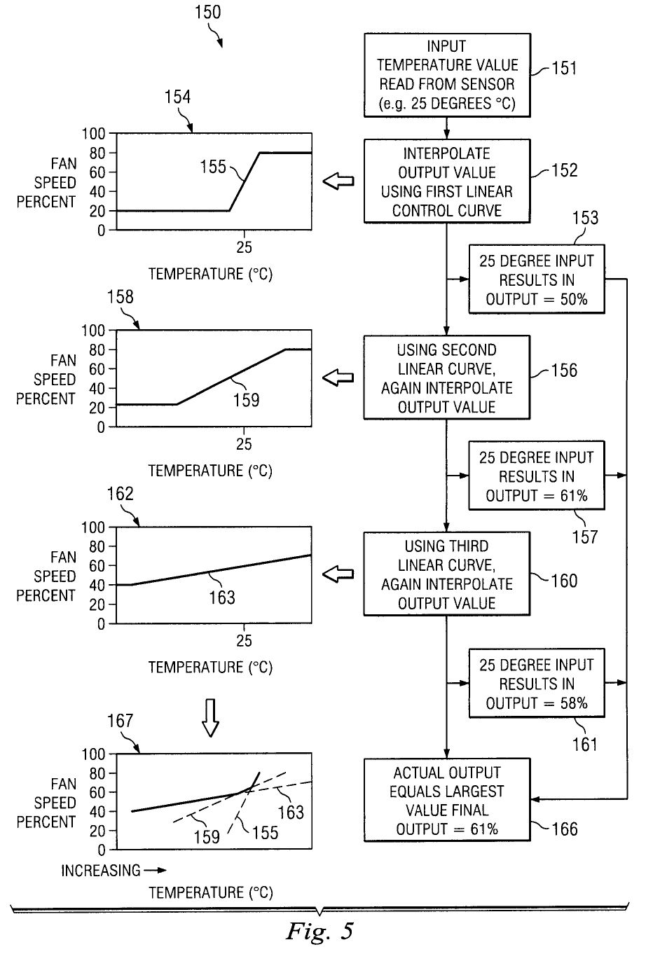

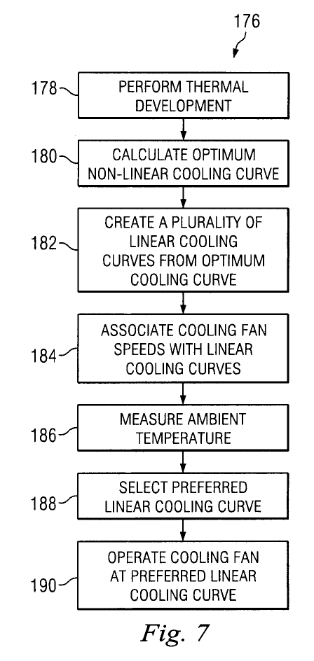

Turning now to FIG. 5, an embodiment of a method of using a plurality of linear cooling curves 150 is provided to result in an optimized non-linear cooling curve. In this example, three cooling curves 154, 158, and 162 are used. However, any number of cooling curves/graphs 154, 158, and 162 can be used for an embodiment of this method 150, so long as there are at least two curves.

The method 150 begins in step 151 where the BMC 128 on the motherboard 101 of the IHS 100 reads an input temperature from the ambient temperature sensor 130. For this example, the ambient temperature of 25 C is used. In other embodiments (not shown), device temperature, device power, or any other feature may be read and used instead of ambient temperature to control the interpolation using the control curves. In step 152, the BMC 128 interpolates a first output value, shown at 50% full fan speed at 155 using the first cooling curve 154. This output is stored at step 153 for comparing with interpolated values using other cooling curves. In step 156, the BMC 128 interpolates a second output value, shown at 61% full fan speed at 159 using the second cooling curve 158. This output is stored at step 157 for comparing with interpolated values using other cooling curves. Next, in step 160, the BMC 128 interpolates a third output value, shown at 58% full fan speed at 163 using the third cooling curve 162. This output is stored at step 161 for comparing with interpolated values using other cooling curves. Once all of the output values have been interpolated using all of the desired cooling curves 154, 158, and 162, the BMC 128 in step 166, in this case, determines the highest value fan output needed for optimal cooling. The highest value is used here so that the object of the cooling, e.g. the IHS 100 hardware, receives enough cooling to prevent overheating. The composite non-linear cooling curve 167 is derived from the substantially linear portions 155, 159, and 163 of the respective cooling curves 154, 158, and 162.

FIG. 6 shows another use for the present cooling system and method where an optimized cooling curve 168 allows for lower fan speeds at given temperatures than those allowed using the standard linear cooling curve 144. In this embodiment, the BMC will obviously not pick the highest value, but rather the lowest value fan speed to conserve the most power and produce the least amount of fan noise. Benefits 170 and 172 are shown where the desired fan speed in this case is below that which would have been required using the single linear curve 144. A benefit 170 is the power/noise savings between the previous low requirement of 146 to the optimized low requirement of 163 using multiple curves. Similarly, a benefit 172 is the savings between the linear requirement of 145 and the optimized cooling fan speeds of 155 and 159.

In practice, the non-linear cooling curves 167 and 168 may be derived from temperature testing or thermal development of the subject of the cooling, such as the IHS 100. The method 176 shows one embodiment for optimizing a cooling system to use existing linear software or firmware to control system fans even though the optimized cooling curves 167, 168 are not linear. In step 178, the object of the cooling, here an IHS 100, is thermally tested to determine fan speeds for optimally cooling the IHS 100 at a full range of ambient temperatures. Then, in step 180 optimum cooling curves are calculated or otherwise derived from the thermal testing of step 178. The resulting cooling curve may resemble the non-linear curves 167 and 168. Next, in step 182, a plurality of substantially linear cooling curves approximately following or relating to portions of the non-linear cooling curve are derived from the non-linear curve. The plurality of substantially linear cooling curves may resemble the cooling curves 154, 158, and 162. Step 184 associates a fan speed, here a percentage of full speed, with the substantially linear cooling curves to create pre-determined outputs to control the fan 132 for given ambient temperatures. Continuing on to step 186, the method 176 has the object of the cooling or here, the BMC 128 measure the ambient temperature (or any other desired input) using the temperature sensor 130. Step 188 then selects a preferred linear cooling curve for the measured input. As indicated above, the selection of a preferred cooling curve may be the highest value, the lowest value, or have any other desired requirement. Finally, step 190 operates the cooling fan 132 at the necessary speed relating to the preferred substantially linear cooling curve for the measured input. As a result, optimum power, airflow, and noise level can be obtained for multiple temperatures using a non-linear cooling curve, while only needing software/firmware that is only capable of controlling the fan 132 linearly.

Steps 178-184 are generally performed by the system developer during system development. The remaining steps, 186-190, in method 176 are generally performed by a user of the method and not necessarily by the developer of the system. Thus, different individuals or different entities may practice different portions of the method 176. It is also understood that other factors or considerations may influence control of the cooling system in addition to ambient temperature.

In summary, the present disclosure provides a system and method to utilize common linear BMC Firmware algorithms to allow an optimized non-linear fan control without the need to implement new, complex, and computation-intensive non-linear algorithms. This method and system involves creating multiple simple linear fan control curves, and overlaying them in a way to produce a piece-wise, multi-stage linear approximation of a true non-linear curve. One embodiment of this method allows existing linear BMC fan control algorithms to provide non-linear fan control without requiring modification of the existing source code. The BMC 128 computes each linear fan control curve independently, and in one embodiment, retains the highest fan output valve after analyzing each linear curve. The resultant effect is that the BMC 128 produces a non-linear output from a set of linear input curves.

By overlaying non-linear curves, a fan speed response to ambient temperature can be optimized across a full range of supported ambient temperatures, such as 10-35 C. Present state of the art fan speed temperature responses for exemplary IHS servers are linearly curve fitted to ambient temperatures of approximately 25-35 C. Fan speeds are static at temperatures below 25 C. Fan speeds could be reduced below 25 C (with data center ambient temperatures of 17-23 C typical) with system airflow and power reductions, however, with a linear fan speed response, component temperatures would be exceeded at lower ambient temperature due to the non-linear mapping of fan speeds and component cooling. Likewise, due to the linear curve fit of fan speed and ambient temperature, components are often overcooled at high ambient temperatures at the expense of system power.

An advantage over existing multistage fan response to ambient temperatures has been developed and implemented in the Dell™, PowerEdge™, 6950 server. An embodiment of the multistage fan response method allows for linear ramp rates over different ranges of ambient conditions. By utilizing the multistage fan response method airflow savings of for example, almost 20% may be realized as well as a fan power savings of, for example, approximately 34%.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A method for non-linear operation of a cooling device, the method comprising:
establishing a non-linear optimum cooling curve for the cooling device;
approximating a plurality of substantially linear cooling curves to relate to portions of the non-linear cooling curve;
selecting one of the plurality of substantially linear cooling curves for operating the cooling device; and
operating the cooling device along the selected one of the plurality of substantially linear cooling curves.

2. The method of claim 1 wherein the non-linear cooling curve for the cooling device relates to cooling device power vs. temperature.

3. The method of claim 2 wherein the temperature is ambient temperature proximate an area desired to be cooled by the cooling device.

4. The method of claim 1 further comprising:
adjusting cooling device power to follow the selected one of the plurality of substantially linear cooling curves.

5. The method of claim 1 further comprising:
selecting a second one of the plurality of substantially linear cooling curves for operating the cooling device as a parameter of the non-linear cooling curve changes; and
adjusting operation of the cooling device from the selected one of the plurality of substantially linear cooling curves to operate along the second one of the plurality of substantially linear cooling curves.

6. The method of claim 1 wherein the operation of the cooling device is operating a direct current (DC) electrical fan.

7. The method of claim 6 wherein the electrical fan is adjusted using pulse width modulation.

8. A system for adjusting operation of a cooling device, the system comprising:
a cooling device;
an input sensory device;
an algorithm that approximates a plurality of substantially linear cooling curves to relate to portions of a non-linear cooling curve for the cooling device, the algorithm provided to select a selected cooling curve from the plurality of substantially linear cooling curves based on an input from the sensory device; and
a controller that adjusts operation of the cooling device to substantially follow the selected cooling curve.

9. The system of claim 8 wherein the cooling device is a fan.

10. The system of claim 8 wherein the input sensory device is an ambient temperature sensor.

11. The system of claim 8 wherein the algorithm is a software program.

12. The system of claim 8 wherein the controller is a baseboard management controller.

13. The system of claim 8 wherein the operation of the cooling device is adjusted by adjusting power level to the cooling device.

14. The system of claim 8 wherein a sum of different selected substantially linear cooling curves creates a non-linear cooling curve.

15. A information handling system comprising:
a processor;
a cooling device for cooling the processor;
an input sensory device for sensing temperature proximate the processor;
an algorithm that approximates a plurality of substantially linear cooling curves to relate to portions of a non-linear cooling curve for the cooling device, the algorithm provided to select a selected cooling curve from the plurality of substantially linear cooling curves based on an input from the sensory device; and
a controller that adjusts operation of the cooling device to substantially follow the selected cooling curve.

16. The system of claim 15 wherein the cooling device is a fan.

17. The system of claim 15 wherein the input sensory device is an ambient temperature sensor.

18. The system of claim 15 wherein the algorithm is a software program.

19. The system of claim 15 wherein the controller is a baseboard management controller.

20. The system of claim 15 wherein the operation of the cooling device is adjusted by adjusting power level to the cooling device.

21. The system of claim 15 wherein a sum of different selected substantially linear cooling curves creates a non-linear cooling curve.
